(19) United States
(12) Patent Application Publication
(10) Pub. No.: US 2024/0242234 A1
(43) Pub. Date: Jul. 18, 2024

(54) INFLUENCE CALCULATING APPARATUS, INFLUENCE CALCULATING METHOD, AND PROGRAM

(71) Applicant: NIPPON TELEGRAPH AND TELEPHONE CORPORATION, Tokyo (JP)

(72) Inventors: Honoka TODA, Tokyo (JP); Shigeru FUJIMURA, Tokyo (JP); Atsushi NAKADAIRA, Tokyo (JP); Shigenori OHASHI, Tokyo (JP); Keita SUZUKI, Tokyo (JP)

(73) Assignee: NIPPON TELEGRAPH AND TELEPHONE CORPORATION, Tokyo (JP)

(21) Appl. No.: 18/558,705

(22) PCT Filed: May 7, 2021
(86) PCT No.: PCT/JP2021/017566

§ 371 Date: Nov. 2, 2023

(51) Int. Cl. G06Q 30/0201; G06Q 50/00

(52) U.S. Cl. CPC G06Q 30/0201; G06Q 50/01

(57) ABSTRACT

An influence calculation apparatus according to one embodiment includes an extraction unit configured to extract a subset related to a given topic from a set composed of a plurality of users on the basis of the topic, a calculation unit configured to calculate an influence of a target user in the subset on the basis of a relationship between the target user included in the subset and another user included in the subset, and a display control unit configured to cause a display unit to display the influence of the target user in the subset.

### TECHNICAL FIELD

The present invention relates to an influence calculation apparatus, an influence calculation method, and a program.

### BACKGROUND ART

In recent years, marketing utilizing users (users called influencers) having a strong influence in social networking services (SNSs) has attracted attention. Such marketing is also called influencer marketing, and involves transmitting information on commodities, services, and the like to influencers on SNSs to improve degrees of recognition of the commodities, services, and the like and the desire to buy the same.

Therefore, in influencer marketing, it is important to evaluate the influence of a user in an SNS (in particular, the influence within a group of users who are interested in a certain topic that is a marketing target). The influence of a user in an SNS is generally evaluated by the number of followers, the number of interactions such as “likes” on a post of the user, and the like. Further, a method of more accurately calculating the influence of a user by adjusting the influence according to purchase of the number of followers, purchase of interaction, and the like has also been proposed, for example.

### CITATION LIST

### Patent Literature

[PTL 1] Japanese Patent Application Publication No. 2013-182602

### SUMMARY OF INVENTION

### Technical Problem

However, conventionally, a group of users who are interested in a certain topic has not been considered. In addition, in terms of characteristics of SNS, habitual or phatic interaction may be performed for posts of a certain user for the reason that users are friends or follow each other, for example.

Therefore, when the influence within a group of users who are interested in a certain topic is evaluated, the influence cannot be accurately evaluated.

An embodiment of the present invention has been devised in view of the aforementioned circumstances, and an object thereof is to accurately evaluate the influence of a user in a specific group.

### Solution to Problem

In order to achieve the above object, an influence calculation apparatus according to one embodiment includes an extraction unit configured to extract a subset related to a given topic from a set composed of a plurality of users on the basis of the topic, a calculation unit configured to calculate an influence of a target user in the subset on the basis of a relationship between the target user included in the subset and another user included in the subset, and a display control unit configured to cause a display unit to display the influence of the target user in the subset.

### Advantageous Effects of Invention

The influence of a user in a specific group can be accurately evaluated.

### BRIEF DESCRIPTION OF DRAWINGS

FIG. 1 is a diagram showing an example of a hardware configuration of an influence calculation apparatus according to the present embodiment.

FIG. 2 is a diagram showing an example of a functional configuration of the influence calculation apparatus according to the present embodiment.

FIG. 3 is a diagram showing an example of a post database.

FIG. 4 is a flowchart showing an example of influence calculation processing according to the present embodiment.

### DESCRIPTION OF EMBODIMENTS

Hereinafter, embodiments of the present invention will be described. In the present embodiment, an influence calculation apparatus 10 capable of accurately evaluating the influence of a certain user in a group of users interested in a certain topic for users on an SNS will be described. Here, a topic is defined as an object, an item, a matter, an event, a topic or the like.

In an SNS, each user can post some content (text, images, moving images, voices, etc.) and performs interactions such as “likes” on the posts. Further, users can have a relationship called “follow (or link)” or the like, and other users who follow a certain user may be called “followers” or the like. A state in which users follow each other is called “mutual follow” or the like.

In influencer marketing, an index called “impression” is also present. An impression represents how many opportunities other users have had to view a certain post. Hereinafter, the number of times a user's post has been displayed to other users is referred to as an “impression” or a “number of impressions.”

However, targeting SNS users is an example and the present invention is not limited thereto, but can be similarly applied to groups having properties the same as or similar to those of an SNS. That is, the present embodiment can be similarly applied when there is a set of subjects corresponding to SNS users, a subset of the set can be extracted with respect to a given topic, a subject can transmit a message similar to a post, other subjects can interact with the message, an impression of the message can be calculated, and a one-way or two-way link can be present between subjects.

### <Hardware Configuration of Influence Calculation Apparatus 10>

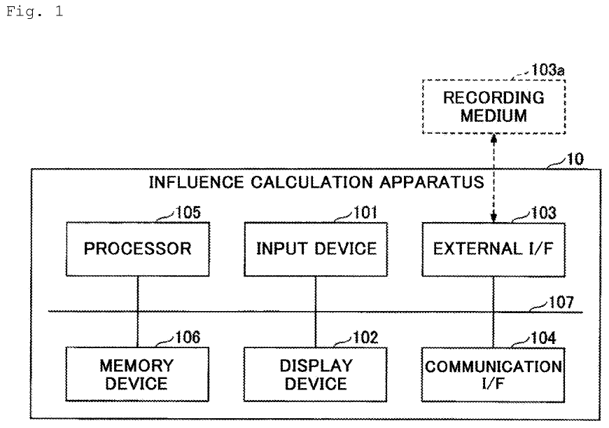

First, a hardware configuration of the influence calculation apparatus 10 according to the present embodiment will be described with reference to FIG. 1. FIG. 1 is a diagram showing an example of the hardware configuration of the influence calculation apparatus 10 according to the present embodiment.

As shown in FIG. 1, the influence calculation apparatus 10 according to the present embodiment is realized by a hardware configuration of a general computer or computer system and includes an input device 101, a display device 102, an external I/F 103, a communication I/F 104, a processor 105, and a memory device 106. These pieces of hardware are connected via a bus 107 such that they can communicate with each other.

The input device 101 is, for example, a keyboard, a mouse, a touch panel, or the like. The display device 102 is, for example, a display or the like. The influence calculation apparatus 10 may not include at least one of the input device 101 and the display device 102.

The external I/F 103 is an interface with an external device such as a recording medium 103a. The influence calculation apparatus 10 can perform reading and writing with respect to the recording medium 103a via the external I/F 103. As the recording medium 103a, for example, a compact disc (CD), a digital versatile disk (DVD), a Secure Digital (SD) memory card, a Universal Serial Bus (USB) memory card, or the like may be conceived.

The communication I/F 104 is an interface for connecting the influence calculation apparatus 10 to a communication network such as the Internet. The processor 105 is, for example, any of various arithmetic devices such as a central processing unit (CPU) and a graphics processing unit (GPU). The memory device 106 is, for example, various storage devices such as a hard disk drive (HDD), a solid state drive (SSD), a random access memory (RAM), a read only memory (ROM), and a flash memory.

The influence calculation apparatus 10 according to the present embodiment can realize influence calculation processing which will be described later with the hardware configuration shown in FIG. 1. The hardware configuration shown in FIG. 1 is merely an example, and the influence calculation apparatus 10 may have a different hardware configuration. For example, the influence calculation apparatus 10 may have a plurality of processors 105 and may have a plurality of memory devices 106.

### <Functional Configuration of Influence Calculation Apparatus 10>

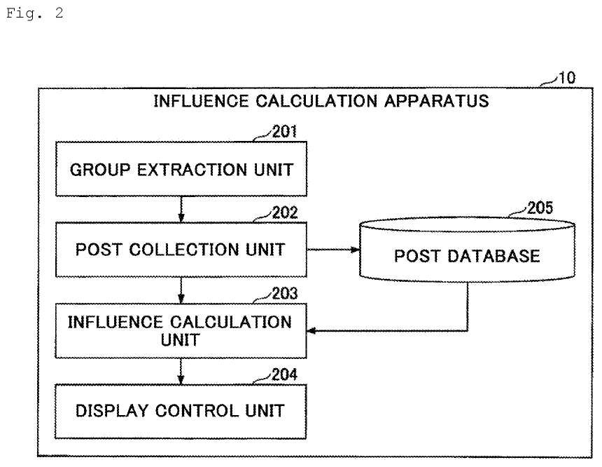

Next, a functional configuration of the influence calculation apparatus 10 according to the present embodiment will be described with reference to FIG. 2. FIG. 2 is a diagram showing an example of the functional configuration of the influence calculation apparatus 10 according to the present embodiment.

As shown in FIG. 2, the influence calculation apparatus 10 according to the present embodiment includes a group extraction unit 201, a post collection unit 202, an influence calculation unit 203, and a display control unit 204. Each of these units is realized by processing for causing the processor 105 to execute one or more programs installed in the influence calculation apparatus 10.

The influence calculation apparatus 10 according to the present embodiment includes a post database 205. The post database 205 is realized by the memory device 106. The post database 205 may also be realized by, for example, a storage device connected to the influence calculation apparatus 10 via a communication network.

The group extraction unit 201 extracts a group of users who are interested in a certain topic (hereinafter referred to as a “target group”).

The post collection unit 202 collects or calculates various types of information about posts of a user whose influence will be evaluated (hereinafter referred to as a “target user”) from an SNS (more accurately, a server providing the SNS) on the basis of the target group extracted by the group extraction part unit 201. Further, the post collection unit 202 creates post data from the collected or calculated information, and stores the post data in the post database 205.

The influence calculation unit 203 calculates the influence of the target user in the target group using the post data stored in the post database 205.

The display control unit 204 displays the influence calculated by the influence calculation unit 203 (that is, the influence of the target user in the target group). Here, the display control unit 204 may display, for example, the influence of the target user in the target group on the display device 102 of the influence calculation apparatus 10, or may display the influence on a display of a terminal connected to the influence calculation apparatus 10 via a communication network.

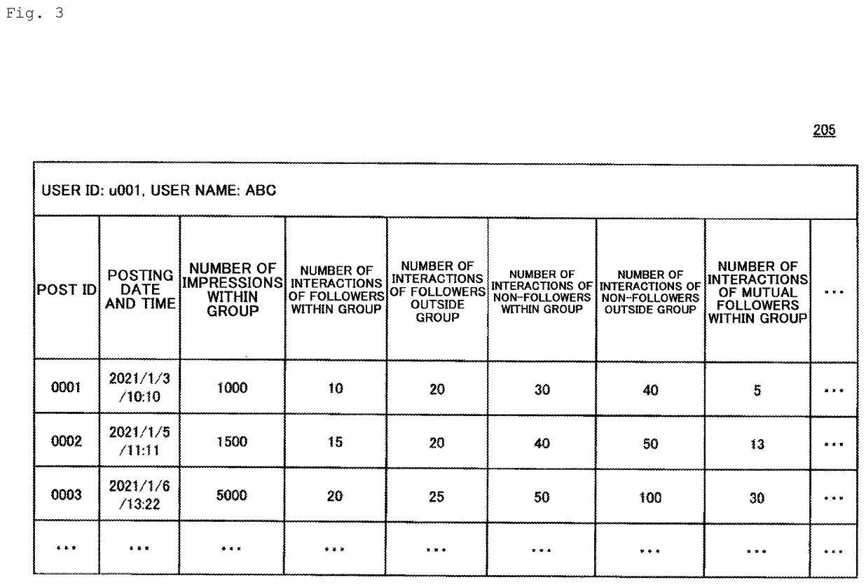

The post database 205 stores post data. Here, an example of the post database 205 will be described with reference to FIG. 3. FIG. 3 is a diagram showing an example of the post database 205.

As an example, the post database 205 shown in FIG. 3 stores a plurality of pieces of post data of user names “u001” and “ABC.” Here, “user name” is identification information for identifying an SNS user, and “user name” is a name used by the SNS user.

In addition, each piece of post data includes information such as “post ID,” “posting date and time,” “number of impressions in group,” “number of interactions of followers within group,” “number of interactions of followers outside group,” “number of interactions of non-followers within group,” “number of interactions of non-followers outside group,” “number of interactions in mutual followers within group,” and the like. This information is information collected or calculated by the post collection unit 202.

“Post ID” is identification information for identifying a post of the corresponding user. “Posting date and time” is the date and the time at which the corresponding posting was performed. “Number of impressions in group” is the sum of impressions of the corresponding post in a target group. “Number of interactions of followers within group” is the sum of interactions with the corresponding post performed by users who are followers of the corresponding user and belong to a target group. “Number of interactions of followers outside group” is the sum of interactions with the corresponding post performed by users who are followers of the corresponding user and do not belong to a target group. “Number of interactions of non-followers within group” is the sum of interactions with the corresponding post performed by users who are not followers of the corresponding user and belong to a target group. “Number of interactions non-followers outside group” is the sum of interactions with the corresponding post performed by users who are not followers of the corresponding user and do not belong to a target group. “Number of interactions of mutual followers within group” is the sum of interactions with the corresponding post performed by users in a mutual follow relationship with the corresponding user in a target group.

Records stored in the post database 205 may include various types of information in addition to the aforementioned information. For example, information representing the content of each post (that is, images, moving images, voice, and the like in addition to text representing the content of the corresponding post) may be included.

As will be described later, since an interaction of a user who does not belong to a target group is not used to calculate an influence in the present embodiment, the “number of interactions of followers outside group” and the “number of interactions of non-followers outside group” may not be included in post data. In this case, such information may not be collected or calculated.

### <Influence Calculation Processing>

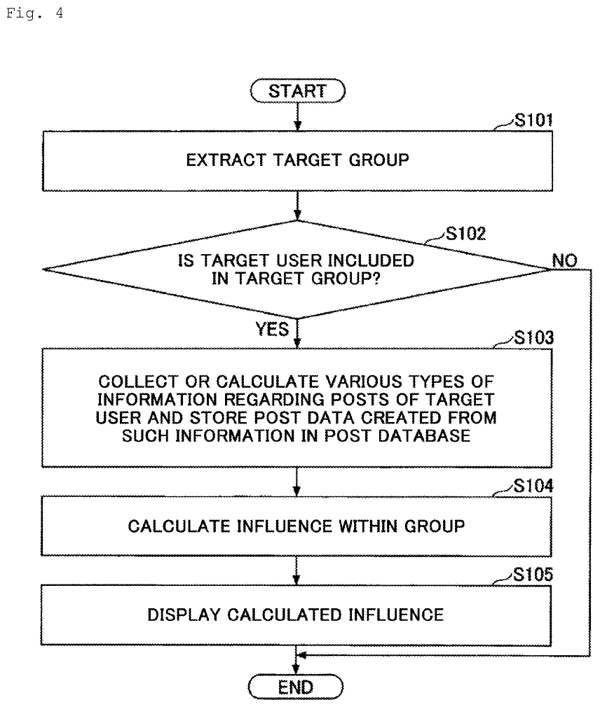

Next, details of influence calculation processing according to the present embodiment will be described with reference to FIG. 4. FIG. 4 is a flowchart showing an example of influence calculation processing according to the present embodiment. Hereinafter, it is assumed that a certain topic and information indicating a target user (e.g., the user ID of the target user or the like) are provided to the influence calculation apparatus 10. The topic and information indicating the target user may be provided through the input device 101 of the influence calculation apparatus 10 or may be provided through a keyboard, a mouse, or the like of a terminal connected to the influence calculation apparatus 10 via a communication network. In addition, two or more pieces of information indicating the target user may be provided, or two or more topics may be provided.

First, the group extraction unit 201 extracts a set of users interested in the topic as a target group (step S101). Here, the group extraction unit 201 may collect user IDs or user names from an SNS (more accurately, a server providing the SNS) and extract a set of users having user IDs or user names including characters or character strings related to the topic as a target group, for example. As a specific example, when it is desired to identify a group of users who are interested in a certain game or character, a set of users having user IDs or user names including characters or character strings representing the game name or character name may be extracted as a target group.

However, the aforementioned extraction method is an example, and the target group may be extracted by various other methods. For example, a user ID or a user name of each user may be expressed as a word vector, and a set of users having user IDs or user names having distances from word vectors representing characters or character strings related to the topic, which are equal to or less than a predetermined threshold value, may be extracted as a target group. Alternatively, for example, posts to which a hashtag representing the topic has been attached are collected from the SNS, and then a set of users who have performed such posts more than a predetermined number of times may be extracted as a target group. A hashtag is a tag or a label which can be given to a post by a user and is generally represented in a form in which a hash symbol is given before a keyword.

In this manner, a target group which is a range for evaluating the influence of a target user is extracted in the present embodiment. Since such a target group is not considered in a conventional method for calculating the influence of a user in an SNS, it is impossible to evaluate the accurate influence on a set of users who are interested in a certain topic.

Next, the group extraction unit 201 determines whether or not the target user is included in the target group extracted in step S101 (step S102).

If it is determined in step S102 that the target user is not included in the target group, the influence calculation apparatus 10 ends the influence calculation processing. In this case, since the target user is not included in the target group, the target user has no influence on each user included in the target group. At this time, the display control unit 204 may display information indicating that the target user has no influence on the target group on the display device 102 of the influence calculation apparatus 10 or a display of a terminal connected via a communication network.

On the other hand, if it is determined in step S102 that the target user is included in the target group, the post collection unit 202 collects or calculates various types of information on posts of the target user from the SNS and stores post data created from the information in the post database 205 (step S103). That is, the post collection unit 202 collects or calculates information such as the “post ID,” “posting date and time,” “number of impressions within group,” “number of interactions of followers within group,” “number of interactions of followers outside group,” “number of interactions of non-followers within group,” “number of interactions of non-followers outside group,” and “number of interactions of mutual followers within target group” regarding each post of the target user, and stores post data composed of the information in the post database 205.

At this time, if each piece of information can be directly collected from the SNS, the post data may be created using the information, but if a certain piece of information cannot be directly collected, the information is calculated from other information and then the post data is created using the calculated information. For example, when the “number of interactions of followers within group” and “number of interactions of followers outside group” cannot be directly collected, whereas the number of interactions of followers and user IDs of followers of the target user can be collected, the “number of interactions of followers within group” and the “number of interactions of followers outside group” may be calculated using the number of interactions of followers, the user IDs of the followers of the target user, and the target group. This can be calculated by simple addition/subtraction. With respect to other information, if the aforementioned information cannot be directly collected from the SNS, the aforementioned information may be calculated from information that can be collected by addition/subtraction or the like in the same manner.

Here, although information for a past period before the present period is collected or calculated in step S103 in general, this period needs to be set appropriately. This is because a processing load increases when information for an excessively long period of time is collected or calculated, and it is considered that the number of impressions and the number of interactions of past posts are less related to the current actual influence of the target user. Therefore, it is desirable to collect or calculate, for example, information for a period of about one month to several months in the past from the present in step S103. Hereinafter, it is assumed that information for a period of one past month from the present is collected or calculated in the above step S103 (accordingly, post data regarding posts for one past month (that is, one latest month) from the present is stored in the post database 205.)

When the influence is calculated using formula (4) which will be described later, the post collection unit 202 also collects the number of followers of each user included in the target group from the SNS in the above step S103.

In this manner, various types of information for calculating the influence of the target user in the target group are collected from the SNS (or calculated from information collected from the SNS) in the present embodiment. In the conventional method for calculating the influence of an SNS user, the aforementioned various types of information are not collected or calculated because a target group is not considered, as described above.

Next, the influence calculation unit 203 calculates the influence of the target user in the target group using the post data stored in the post database 205 (step S104).

Hereinafter, it is assumed that post data regarding n posts of the target user for the past one month (latest one month) (that is, post data regarding each post i with i∈[1, n]) is stored in the post database 205.

### Influence Calculation Example 1

In this case, as an example, the influence calculation unit 203 calculates the influence of the target user in the target group using the following formula (1).

$$\begin{matrix}[ Math . 1 ] & \\ {\sum }_{i = 1}^{n} ( \frac{{x}_{i} - {y}_{i}}{{z}_{i}} ) & ( 1 )\end{matrix}$$

Here, n is the number of posts for one past month (latest one month), xᵢ is the number of interactions with a post i from a user included in the target group, yᵢ is the number of interactions with the post i from a user who is included in the target group and is a mutual follower, and zᵢ is the number of impressions of the post i in the target group. Here, xᵢ is the sum of the “number of interactions of followers within group” and the “number of interactions of non-followers within group” with respect to the post i.

That is, the influence is calculated after interactions from users who are mutual followers are eliminated according to formula (1). Accordingly, habitual or phatic interactions for the reason that users are friends or follow each other, and the like are excluded, for example, and the influence of the target user in the target group can be accurately evaluated. Here, it is based on the assumption that friends are usually mutual followers.

Although xᵢ is the number of interactions with the post i from users included in the target group in formula (1), the present invention is not limited thereto, and the number of interactions with the post i from users who are not followers and belong to the target group may be xᵢ, for example.

### Influence Calculation Example 2

The value b of an interaction of a certain user is represented by the following formula (2).

$$\begin{matrix}[ Math . 2 ] & \\ b = 1 - ( \frac{c}{n} ) & ( 2 )\end{matrix}$$

Here, c is the number of times the user has made an interaction among the number n of posts.

That is, when the frequency of interaction from the same user is high, the value decreases, and when the frequency is low, the value increases. Hereinafter, the number of users excluding a target user in a target group is defined as m, and each user excluding the target user is defined as a user j.

At this time, the influence of the target user in the target group is calculated using formula (2) in consideration of the value of the interaction of each user j. This is calculated by replacing xᵢ-yᵢ in formula (1) with b in formula (2). Specifically, the calculation is performed using the following formula (3).

$$\begin{matrix}[ Math . 3 ] & \\ {\sum }_{i = 1}^{n} ( {\sum }_{j = 1}^{m} \frac{{b}_{ji}}{{z}_{i}} ) & ( 3 )\end{matrix}$$

Here, bⱼᵢ is an interaction value of the user j with respect to post i. It should be noted that, from the definition of formula (2), bⱼᵢ=bⱼ for i∈[1, n], but it may be different for each post i. For example, the newer the posting date and time, the larger the bⱼᵢ, and the older the posting date and time, the smaller the bⱼᵢ.

Accordingly, the influence in consideration of the interaction value of each user in the target group can be calculated. Therefore, as in the above-described influence calculation example 1, it is possible to exclude habitual or phatic interactions, for example, for the reason that users are friends or follow each other, and to accurately evaluate the influence of the target user in the target group. Here, it is based on the assumption that friends and mutually following users usually perform interaction frequently.

### Influence Calculation Example 3

With respect to the above-described influence calculation example 2, the influence of the target user in the target group is calculated in consideration of the number of followers of users other than the target user. Specifically, the influence of the target user in the target group is calculated using the following formula (4).

$$\begin{matrix}[ Math . 4 ] & \\ {\sum }_{i = 1}^{n} ( {\sum }_{j = 1}^{m} \frac{{f}_{ji} {b}_{ji}}{{z}_{i}} ) & ( 4 )\end{matrix}$$

Here, fⱼᵢ is the number of followers of a user j. Although fⱼᵢ=fⱼ may be used for i∈[1, n], the number fⱼᵢ of followers of the user j for post i and the number of f_{ji′} of followers of the user j for post i′ may be different, for example, and thus fⱼᵢ is used.

Accordingly, it is possible to calculate the influence considering the number of followers of each user in the target group in addition to the interaction value of each user. This is because interactions from a user having a large number of followers are considered to have high values.

Although an influence is also calculated by multiplying a reference value by the number of followers in the conventional method for calculating the influence of a user in an SNS, an influence is not calculated by using formula (3) as a reference and multiplying it by the number of followers as in the present embodiment.

In any of the above-described influence calculation examples 1 to 3, since the influence by blind interactions based on mutual follow can be excluded or mitigated, the influence of the target user in the target group can be evaluated correctly or accurately. Although conventional methods for calculating the influence of a user in an SNS include methods for adjusting the influence according to purchase of the number of followers, purchase of interactions, or the like (that is, reducing the influence), it is considered that there is no method for eliminating or mitigating the influence of blind interactions based on mutual follow as described in the present embodiment.

Subsequently to the step S104, the display control unit 204 displays the influence calculated in step S104 (that is, the influence of the target user in the target group) on the display device 102 of the influence calculation apparatus 10 or on a display of a terminal connected via a communication network (step S105).

Here, although content displayed by the display control unit 204 can be considered in various manners, for example, the user ID and the user name of the target user, the topic, the user ID and the user name of each user included in the target group are displayed in addition to the influence of the target user in the target group. Accordingly, a person who performs influencer marketing (or the target user himself/herself or the like), for example, can evaluate what kind of users constituting a group and how much the target user has influence in the group.

At this time, in order to indicate which formula is used to calculate an influence, the display control unit 204 may display a formula (formula (1), (3) or (4)) used to calculate an influence or display the content of the corresponding formula by text, a diagram, or the like along with the formula (or instead of this formula).

Further, when a plurality of target users are provided, for example, the display control unit 204 may display the influence of each target user and ranking. At this time, ranking of the influence of each target user may be ranking based on the magnitude relation of numerical values representing influences or may be ranking for the influence of each target user. A rank represents, for example, which numerical value width representing an influence among a plurality of predetermined numerical value widths includes a numerical value representing an influence, and A, B, C, and the like are ranked in order from the number value width corresponding to high influence, for example.

Although an influence is ranked and displayed on a display or the like even in conventional methods, it is considered that the influence of a target user in a target group is not ranked.

### SUMMARY

As described above, the influence calculation apparatus 10 according to the present embodiment can calculate the influence of a certain user in a group of users who are interested in a certain topic for SNS users. At this time, the influence calculation apparatus 10 according to the present embodiment can exclude or mitigate the influence of a user who mutually follows the target user, for example, to exclude or mitigate the influence of habitual or phatic interactions on the influence. Therefore, when a person who performs influencer marketing or a target user himself/herself evaluates an influence, for example, more accurate evaluation can be performed.

Although information indicating a topic and a target user is provided to the influence calculation apparatus 10 in the present embodiment, only information indicating the target user may be provided, for example. In this case, a topic in which the target user is interested is identified from the user ID, the user name, or the like, and a set of users interested in in the identified topic may be set as a target group.

The present invention is not limited to the specifically disclosed embodiments, and various modifications, changes, combinations with known techniques, and the like can be made without departing from the scope of the claims.

### REFERENCE SIGNS LIST

10 Influence calculation apparatus
101 Input device
102 Display device
103 External I/F
103a Recording medium
104 Communication I/F
105 Processor
106 Memory device
107 Bus
201 Group extraction unit
202 Post collection unit
203 Influence calculation unit
204 Display control unit
205 Post database

1. An influence calculation apparatus comprising a processor configured to execute operations comprising:
extracting a subset of a set of a plurality of users from the set of the plurality of users, wherein the subset of the plurality of users is associated with posting data of a topic;
calculating an influence of a target user in the subset on the basis of a relationship between the target user included in the subset and another user included in the subset; and
causing display the influence of the target user in the subset.

2. The influence calculation apparatus according to claim 1, wherein the relationship indicates that there is a two-way link between the target user and the other user, and
the calculating further comprises calculating the influence obtained by eliminating or reducing an influence from the other user having a bidirectional link with respect to the target user.

3. The influence calculation apparatus according to claim 1, wherein the relationship indicates a frequency of interaction performed by the other user with respect to a message transmitted by the target user, and
the calculating further comprises calculating the influence obtained by reducing the influence from the other user in accordance with the frequency of interaction.

4. The influence calculation apparatus according to claim 3, wherein the calculating further comprises calculating the influence obtained by reducing the influence from the other user in accordance with the frequency of interaction and a number of users for whom there are one-way or two-way links with the other user.

5. The influence calculation apparatus according to claim 1, wherein the causing display further comprises causing display in either the influence calculation apparatus or another apparatus connected to the influence calculation apparatus via a communication network.

6. An influence calculation method, comprising:
extracting a subset of a set of a plurality of users from the set of the plurality of users, wherein the subset of the plurality of users is associated with posting data of a topic;
calculating an influence of a target user in the subset on the basis of a relationship between the target user included in the subset and another user included in the subset; and
causing a display unit to display the influence of the target user in the subset.

7. A computer-readable non-transitory recording medium storing computer-executable program instructions that when executed by a processor cause computer to execute operations comprising:
extracting a subset of a set of a plurality of users from the set of the plurality of users, wherein the subset of the plurality of users is associated with posting data of a topic;
calculating an influence of a target user in the subset on the basis of a relationship between the target user included in the subset and another user included in the subset; and
causing a display unit to display the influence of the target user in the subset.

8. The influence calculation apparatus according to claim 1, further comprising:
retrieving a plurality of posting data of the target user over a network; and
storing the plurality of posting data of the target user in a posting database, wherein the calculating further comprises:
retrieving the posting data from the posting database, and
calculating, based the plurality of posting data in the posting database, the influence of the target user in the subset.

9. The influence calculation apparatus according to claim 8, wherein the posting database includes a plurality of sets of a user name of the target user and a piece of posting data of the target user, and the piece of posting data comprises an identifier of the piece of posting data, a posting date and time, a number of impressions in a group, a number of interactions of followers in the group, and a number of interactions of followers outside the group.

10. The influence calculation apparatus according to claim 2, wherein the causing display further comprises causing display in either the influence calculation apparatus or another apparatus connected to the influence calculation apparatus via a communication network.

11. The influence calculation method according to claim 6, wherein the relationship indicates that there is a two-way link between the target user and the other user, and
the calculating further comprises calculating the influence obtained by eliminating or reducing an influence from the other user having a bidirectional link with respect to the target user.

12. The influence calculation method according to claim 6, wherein the relationship indicates a frequency of interaction performed by the other user with respect to a message transmitted by the target user, and
the calculating further comprises calculating the influence obtained by reducing the influence from the other user in accordance with the frequency of interaction.

13. The influence calculation method according to claim 12, wherein
the calculating further comprises calculating the influence obtained by reducing the influence from the other user in accordance with the frequency of interaction and a number of users for whom there are one-way or two-way links with the other user.

14. The influence calculation method according to claim 6, wherein the causing display further comprises causing display in either the influence calculation apparatus or another apparatus connected to the influence calculation apparatus via a communication network.

15. The influence calculation method according to claim 6, further comprising:
retrieving a plurality of posting data of the target user over a network; and
storing the plurality of posting data of the target user in a posting database, wherein the calculating further comprises:
retrieving the posting data from the posting database, and
calculating, based the plurality of posting data in the posting database, the influence of the target user in the subset.

16. The influence calculation method according to claim 15, wherein the posting database includes a plurality of sets of a user name of the target user and a piece of posting data of the target user, and the piece of posting data comprises an identifier of the piece of posting data, a posting date and time, a number of impressions in a group, a number of interactions of followers in the group, and a number of interactions of followers outside the group.

17. The computer-readable non-transitory recording medium according to claim 7, wherein the relationship indicates that there is a two-way link between the target user and the other user, and
the calculating further comprises calculating the influence obtained by eliminating or reducing an influence from the other user having a bidirectional link with respect to the target user.

18. The computer-readable non-transitory recording medium according to claim 7, wherein the relationship indicates a frequency of interaction performed by the other user with respect to a message transmitted by the target user, and
the calculating further comprises calculating the influence obtained by reducing the influence from the other user in accordance with the frequency of interaction.

19. The computer-readable non-transitory recording medium according to claim 18, wherein
the calculating further comprises calculating the influence obtained by reducing the influence from the other user in accordance with the frequency of interaction and a number of users for whom there are one-way or two-way links with the other user.

20. The computer-readable non-transitory recording medium according to claim 7, the computer-executable program instructions when executed further causing the computer system to execute operations comprising:
retrieving a plurality of posting data of the target user over a network; and
storing the plurality of posting data of the target user in a posting database,
wherein the calculating further comprises:
retrieving the posting data from the posting database, and
calculating, based the plurality of posting data in the posting database, the influence of the target user in the subset, and
the posting database includes a plurality of sets of a user name of the target user and a piece of posting data of the target user, and the piece of posting data comprises an identifier of the piece of posting data, a posting date and time, a number of impressions in a group, a number of interactions of followers in the group, and a number of interactions of followers outside the group.
